(19) United States
(12) Patent Application Publication
(10) Pub. No.: US 2026/0195205 A1
(43) Pub. Date: Jul. 9, 2026

(54) INFORMATION PROCESSING APPARATUS, INFORMATION PROCESSING METHOD, AND COMPUTER PROGRAM PRODUCT

(71) Applicant: KABUSHIKI KAISHA TOSHIBA, Kawasaki-shi Kanagawa (JP)

(72) Inventors: Myungsook KO, Ota Tokyo (JP); Toru YANO, Shinagawa Tokyo (JP)

(73) Assignee: KABUSHIKI KAISHA TOSHIBA, Kawasaki-shi Kanagawa (JP)

(21) Appl. No.: 19/439,733

(22) Filed: Jan. 5, 2026

(30) Foreign Application Priority Data
Jan. 6, 2025 (JP) 2025-000060

(51) Int. Cl. G06F 11/00

(52) U.S. Cl. CPC G06F 11/004; G06F 2201/81

(57) ABSTRACT

An information processing apparatus includes a processing unit including at least one hardware-processor. The processing unit extracts, from pieces of event data, first event data representing an event that occurs in the first device in an extraction-period before a reference-time-point based on a work in accordance with the occurred event in the first device as a state-estimation-target. The processing unit estimates the state of the first device by inputting the first-feature-information of the first event data to the model inputting the feature-information of the event data and outputting a state-estimation-result of the device. The processing unit uses a determination-rule for determining whether the feature-information of the event data in the extraction-period is a non-target for estimation by the model to determine whether the first-feature-information is the non-target for estimation by the model. The processing unit outputs a state-estimation-result by the model and a determination-result by the determination-rule.

### SPECIFICATION

### CROSS-REFERENCE TO RELATED APPLICATIONS

This application is based upon and claims the benefit of priority from Japanese Patent Application No. 2025-000060, filed on January 6, 2025; the entire contents of which are incorporated herein by reference.

### FIELD

Embodiments described herein relate generally to an information processing apparatus, an information processing method, and a computer program product.

### BACKGROUND

There is known a technique of preventive maintenance in which an occurrence factor of an error that does not lead to a failure but frequently occurs is estimated from a tendency of data collected from a large number of operating devices and presented to, for example, a maintenance worker. In addition, a technique for estimating a failure location (failure location) of a device to be maintained when a problem occurs in an operating device and maintenance is required is known.

Even if there is a notification of occurrence of an event (event issuing) represented by an error, the location (part) having a causal relationship with the occurrence of the event is not necessarily a true failure location (part). However, in a case where a problem requiring maintenance occurs, it is difficult to estimate a failure not associated with the event that occurs during a certain length of time before the occurrence.

### BRIEF DESCRIPTION OF THE DRAWINGS

FIG. 1 is a block diagram of an information processing apparatus according to an embodiment;

FIG. 2 is a diagram illustrating an example of a data structure of maintenance-ready data;

FIG. 3 is a diagram illustrating an example of a data structure of learning data;

FIG. 4 is a diagram illustrating an example of a model expressed in a form of a decision tree;

FIG. 5 is a diagram illustrating an example of a data structure of model data;

FIG. 6 is a diagram illustrating an example of a data structure of accuracy data;

FIG. 7 is a diagram illustrating an example of a data structure of event data;

FIG. 8 is a diagram illustrating an example of a data structure of non-target data;

FIG. 9 is a diagram illustrating an example of a data structure of an estimation rule;

FIG. 10 is a diagram illustrating an example of a data structure of a non-target determination rule;

FIG. 11 is a diagram illustrating another example of the data structure of the non-target determination rule;

FIG. 12 is a diagram illustrating an example of a data structure of non-target state data;

FIG. 13 is a flowchart of estimation processing according to the embodiment;

FIG. 14 is a flowchart of non-target determination processing according to the embodiment;

FIG. 15 is a flowchart of determination rule learning processing according to the embodiment;

FIG. 16 is a flowchart of estimation rule generation processing according to the embodiment;

FIG. 17 is a view illustrating an example of a display screen;

FIG. 18 is a diagram illustrating an example of display information; and

FIG. 19 is a hardware configuration diagram of the information processing apparatus according to the embodiment.

### DETAILED DESCRIPTION

According to an embodiment, an information processing apparatus includes a processing unit including at least one hardware-processor. The processing unit extracts, from pieces of event data, first event data representing an event that occurs in the first device in an extraction-period before a reference-time-point based on a work in accordance with the occurred event in the first device as a state-estimation-target. The processing unit estimates the state of the first device by inputting the first-feature-information of the first event data to the model inputting the feature-information of the event data and outputting a state-estimation-result of the device. The processing unit uses a determination-rule for determining whether the feature-information of the event data in the extraction-period is a non-target for estimation by the model to determine whether the first-feature-information is the non-target for estimation by the model. The processing unit outputs a state-estimation-result by the model and a determination-result by the determination-rule.

Hereinafter, a preferred embodiment of an information processing apparatus according to the present disclosure will be described in detail with reference to the accompanying drawings.

The device applicable to the embodiment may be any device, for example, a device provided in the market and used and operated by a large number of users. Examples of such a device include a Multifunction Peripheral (MFP).

Hereinafter, an example of estimating a failure (failure cause, failure location) as the state of the device will be mainly described. The state of the device to be estimated is not limited to failure. For example, an operating state other than failure, an operating region, and the like may be estimated as the state of the device.

The target device (first device) to be the state estimation target is, for example, a specific device at a certain date and time, a plurality of devices, or a plurality of devices meeting a specific condition. For example, the target device may be the following devices.

A device in which some sort of problem occurs during operation and an inquiry occurs from a user

A plurality of devices owned by the same user

Device with common options, models, regions, manufacturing generations, manufacturing lines, etc.

In the following embodiments, an example in which one specific device is a target device will be described. That is, the state is determined for one specific device. For example, in a case where an inquiry is received from the user as a result of occurrence of some sort of problem and maintenance is required, the state (failure location or the like) of the target device is estimated.

For example, in a case where a response request or an inquiry occurs from a user regarding an operation of a device in operation, the information processing apparatus according to the embodiment estimates and outputs a state (failure location or the like) when maintenance is conducted on the target device by using a history of event data and a history of maintenance handling (a maintenance work), and outputs information capable of specifying a failure case that cannot be estimated by the event data. The event data is data representing an event that occurs in the operating device.

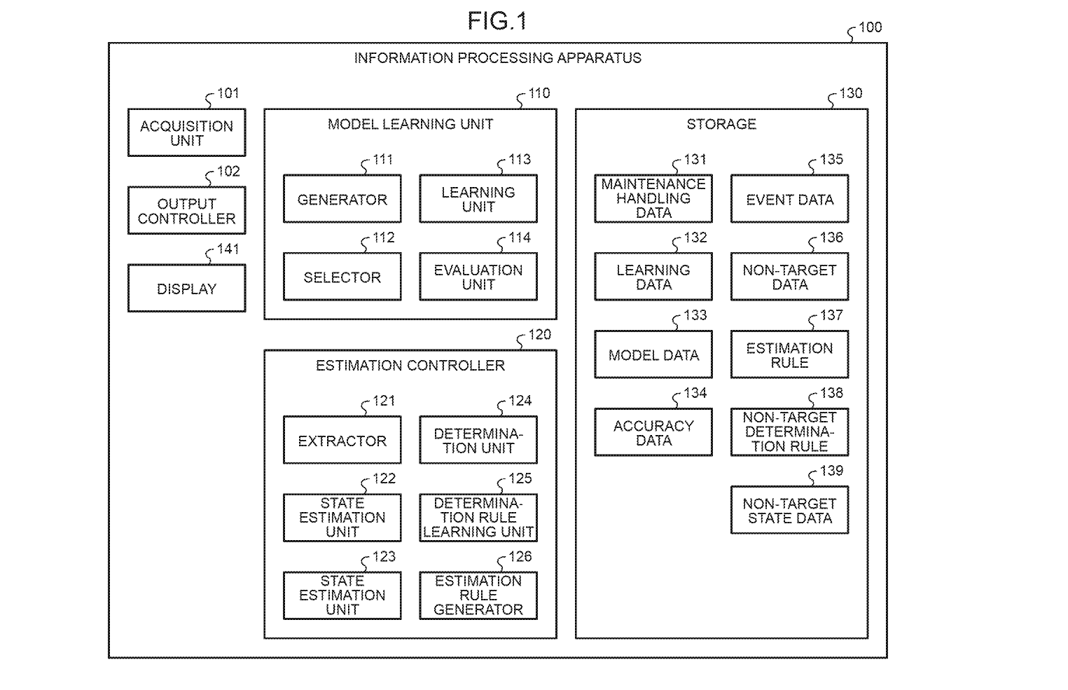

FIG. 1 is a block diagram illustrating an example of a configuration of an information processing apparatus 100 according to an embodiment. As illustrated in FIG. 1, the information processing apparatus 100 includes an acquisition unit 101, an output controller 102, a model learning unit 110, an estimation controller 120, storage 130, and a display 141.

The acquisition unit 101 acquires various types of information used in the information processing apparatus 100. For example, the acquisition unit 101 acquires maintenance handling data indicating a history of maintenance handling, event data, and the like. A method of acquiring information by the acquisition unit 101 may be any method, and for example, a method of receiving information from an external device via a network, a method of acquiring information input by an input device such as a keyboard, a method of reading information from a storage medium, and the like can be applied.

The output controller 102 controls output of various types of information used in the information processing apparatus 100. For example, the output controller 102 outputs an estimation result or the like by the estimation controller 120. The information output method may be any method, and for example, a method of displaying on a display device such as the display 141, a method of transmitting information to an external device via a network, and the like can be applied.

The model learning unit 110 is a configuration unit for learning a model used for estimating the state of the device. The model learning unit 110 includes a generator 111, a selector 112, a learning unit 113, and an evaluation unit 114. Details of the model learning unit 110 will be described later.

The estimation controller 120 is a configuration unit for controlling estimation of the state of the device using the learned model. The estimation controller 120 includes an extractor 121, a state estimation unit 122, a state estimation unit 123, a determination unit 124, a determination rule learning unit 125, and an estimation rule generator 126. Details of the estimation controller 120 will be described later.

At least a part of each unit (the acquisition unit 101, output controller 102, the model learning unit 110, and the estimation controller 120) may be realized by one or more processing units. Each of the above units is realized by, for example, one or a plurality of processors. For example, each of the above units may be realized by causing a processor such as a Central Processing Unit (CPU) and a Graphics Processing Unit (GPU) to execute a program, that is, by software. Each of the above-described units may be realized by a processor such as a dedicated Integrated Circuit (IC), that is, hardware. Each of the above-described units may be realized by using software and hardware in combination. When a plurality of processors is used, each processor may implement one of the units or two or more of the units.

The storage 130 stores various types of information used in the information processing apparatus. For example, the storage 130 stores maintenance handling data 131, learning data 132, model data 133, accuracy data 134, event data 135, non-target data 136, an estimation rule 137, a non-target determination rule 138, and non-target state data 139. Details of each data will be described later.

Note that the storage 130 can be configured by any commonly used storage medium such as a flash memory, a memory card, a Random Access Memory (RAM), a Hard Disk Drive (HDD), and an optical disc.

Part or all of each data (the maintenance handling data 131, the learning data 132, the model data 133, the accuracy data 134, the event data 135, the non-target data 136, the estimation rule 137, the non-target determination rule 138, and the non-target state data 139) stored in the storage 130 may be stored in physically different storage media, or may be stored in different storage areas of the physically same storage medium.

The display 141 is a display device for displaying various types of information, and is realized by, for example, a liquid crystal display, a touch panel, and the like.

The information processing apparatus 100 may be physically configured by one apparatus or may be physically configured by a plurality of apparatuses. For example, the information processing apparatus 100 may be constructed on a cloud environment. Furthermore, each unit in the information processing apparatus 100 may be dispersedly provided in a plurality of apparatuses. For example, the information processing apparatus 100 (information processing system) may be configured to include an apparatus (For example, a learning device) including a function (such as the model learning unit 110) necessary for learning a model and an apparatus (For example, the estimation device) including a function (such as the estimation controller 120) necessary for estimation processing using a learned model.

Next, each data stored in the storage 130 will be described.

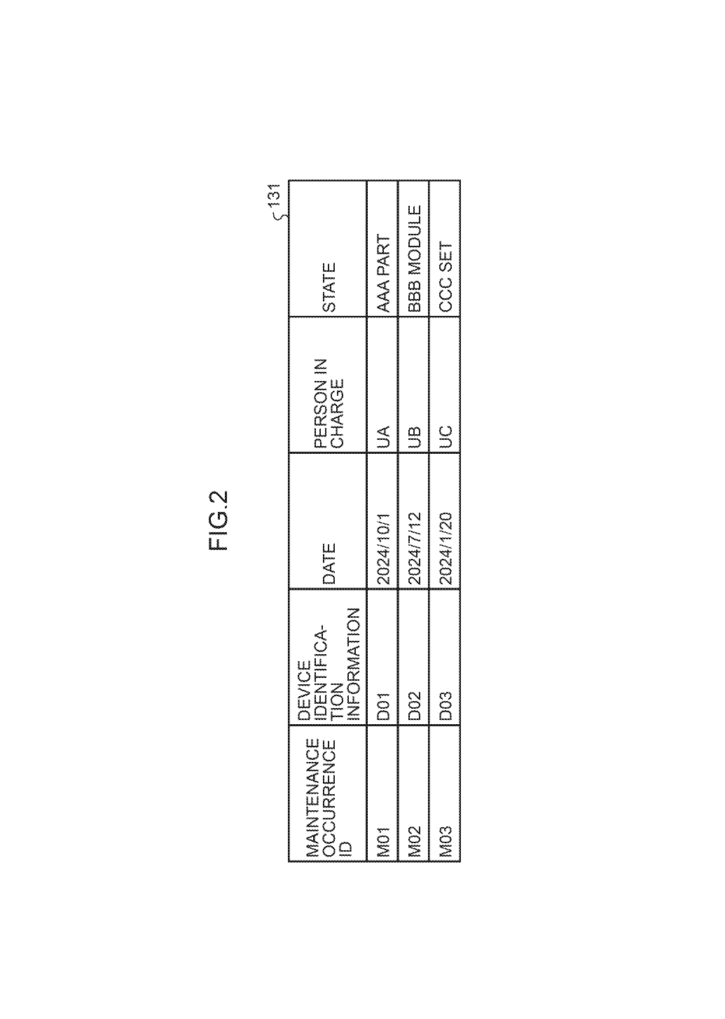

FIG. 2 is a diagram illustrating an example of a data structure of the maintenance handling data 131. The maintenance handling data 131 is acquired by, for example, the acquisition unit 101 and stored in the storage 130. The maintenance handling data 131 includes a maintenance occurrence ID, device identification information, a date, a person in charge, and a state. The maintenance occurrence ID represents identification information for identifying the maintenance handling that takes place. The device identification information represents identification information (such as a serial number) for identifying a target device for the maintenance to be conducted. The date represents the date on which maintenance occurs. Instead of the date, date and time including time (date and time of occurrence of maintenance handling) may be stored. The person in charge represents information for identifying a maintenance worker who conducts maintenance. The state represents a state of the target device, for example, represents a failure location specified by maintenance handling.

The maintenance handling data 131 in FIG. 2 is an example, and may further include other elements. For example, the maintenance handling data 131 may include information indicative of a work conducted in maintenance, a cause of occurrence of a state, and the like.

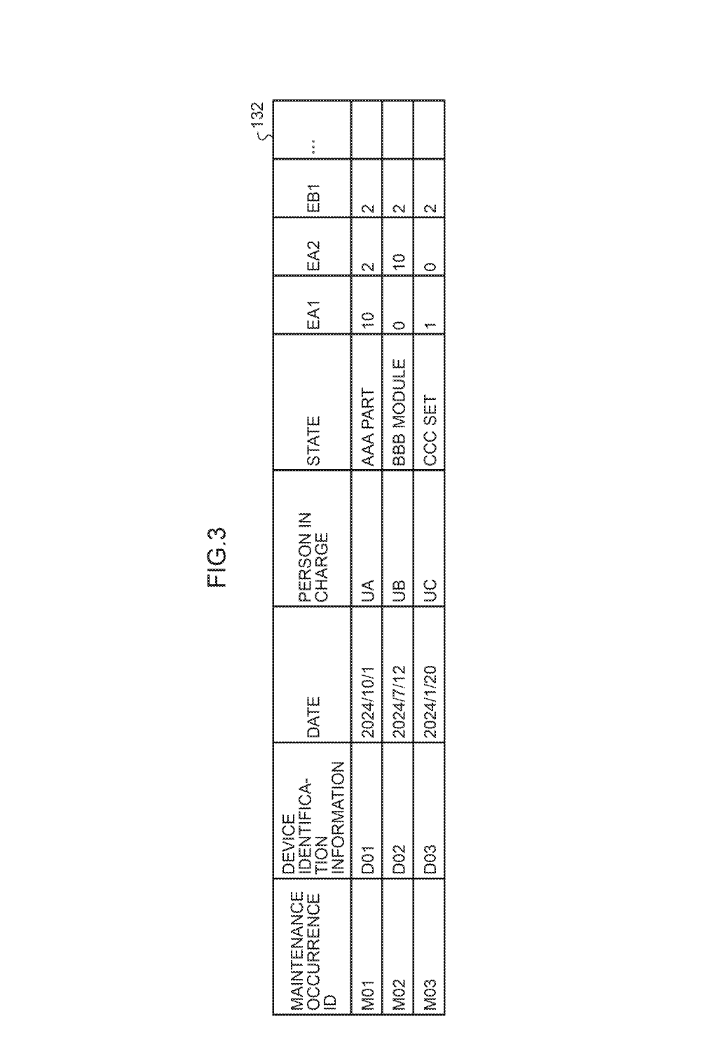

FIG. 3 is a diagram illustrating an example of a data structure of the learning data 132. The learning data 132 is data used for model learning. The learning data 132 is generated by the generator 111, for example, and is stored in the storage 130.

As illustrated in FIG. 3, the learning data 132 includes the occurrence count for each event in addition to each element (maintenance occurrence ID, device identification information, date, person in charge, state) of the maintenance handling data 131. In FIG. 3, EA1, EA2, and EB1 represent identification information (hereinafter, an event ID) for identifying an event. The occurrence count represents the number of the occurrences of the applicable event in a period (hereinafter, an extraction period) of a certain length before the reference time point TA. The reference time point TA represents a time point based on a work according to an event, and is, for example, a time point when a problem that requires maintenance handling occurs. The certain length may be set by acquiring a designated value by the acquisition unit 101, or may be set to a predetermined value (default value).

The event is, for example, an error that occurs in the device, but is not limited thereto. The event may be a specific operation of the device that is different from the error. The event IDs "EA1", "EA2", and "EB1" are, for example, identification information of events representing different errors or actions, respectively.

The occurrence count for each event can be interpreted as information (feature information) indicating feature of one record of the maintenance handling data 131. Hereinafter, a vector including the occurrence count for each event as an element may be referred to as a feature vector (feature vector X). Instead of the occurrence count for each event, information indicating the presence or absence of occurrence for each event may be used as the feature information. In this case, a condition of whether the feature information indicates presence or absence of occurrence is used for classification by the model or the like.

The model data 133 is data representing a model used for estimation by the state estimation unit 122. The model data 133 is generated by learning by the model learning unit 110, for example, and is stored in the storage 130.

The model is generated, for example, for each type of the device (device type). Furthermore, a plurality of types of models may be generated according to a state to be estimated. At the time of learning, different learning parameters may be designated for each model type. Which model type to learn and which model type to use are designated by the user, for example.

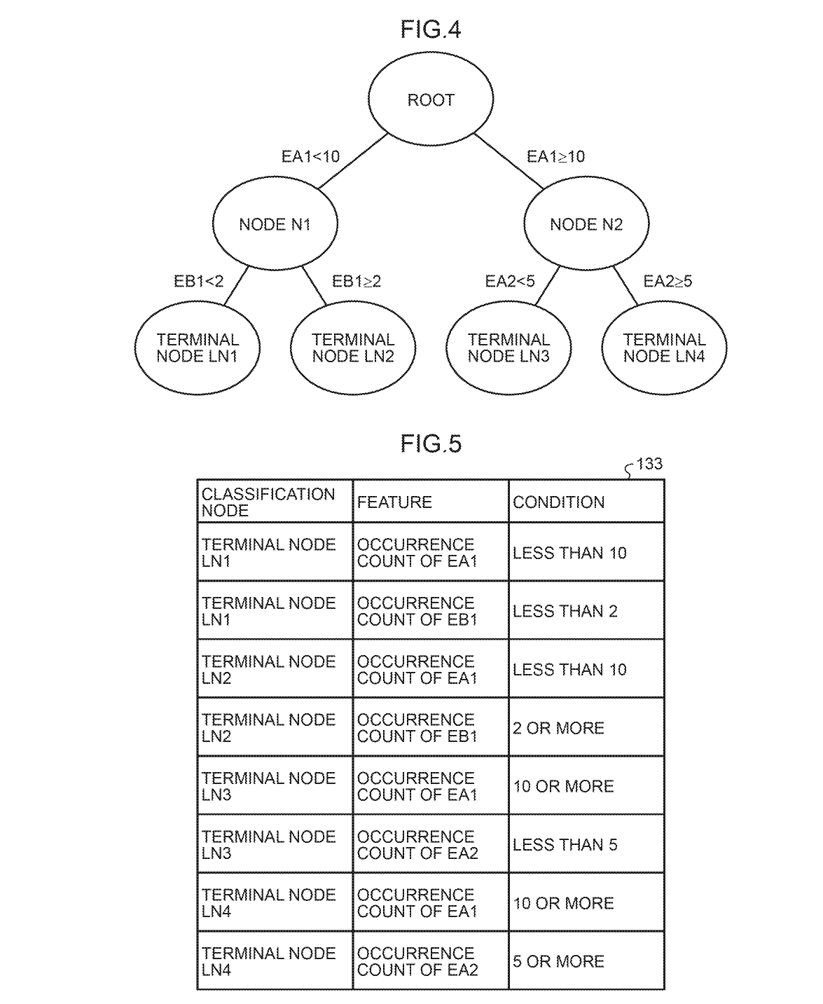

Although the model may be a model having any structure, a model in the form of a decision tree will be described below as an example. FIG. 4 is a diagram illustrating an example of a model expressed in the form of a decision tree.

The model is a model that inputs a feature vector X (feature information) of one or more pieces of event data and outputs an estimation result of the state of the target device. For example, the model classifies the feature vector X stepwise from the root node toward the terminal node according to the occurrence count of the specific event included in the input feature vector X and the condition. A state corresponding to the classified terminal node is output as an estimation result by the model.

FIG. 4 illustrates an example of a three-level decision tree including a root node, nodes N1 and N2 that are two child nodes of the root node, terminal nodes LN1 and LN2 that are child nodes of the node N1, and terminal nodes LN3 and LN4 that are child nodes of the node N2. Note that the decision tree is not limited to three levels, and may be two levels or four or more levels. The decision tree is not limited to the binary tree, and at least some of the nodes may have three or more child nodes.

A condition for classification (branching) into child nodes is applied to an edge between nodes. For example, a condition "EA1 <10" is given to an edge from the root node to the node N1. This condition represents a condition that the occurrence count of an event (specific event) whose event ID is "EA1" is less than 10.

The model data 133 corresponds to data representing a model (decision tree) as illustrated in FIG. 4. FIG. 5 is a diagram illustrating an example of a data structure of the model data 133. The model data 133 includes a classification node, feature, and a condition. The classification node represents a node obtained as a classification category as a result of classification by the feature and the condition. The feature is data used for classification in the feature vector X, and is, for example, the occurrence count of a specific event.

For example, when the occurrence count of the event with the event ID "EA1" is less than 10 and the occurrence count of the event with the event ID "EB1" is less than 2, the classification node becomes the terminal node LN1.

The accuracy data 134 is data obtained at the time of learning the model, and is data representing the accuracy of estimation by the model. The accuracy data 134 is generated by the evaluation unit 114, for example, and is stored in the storage 130.

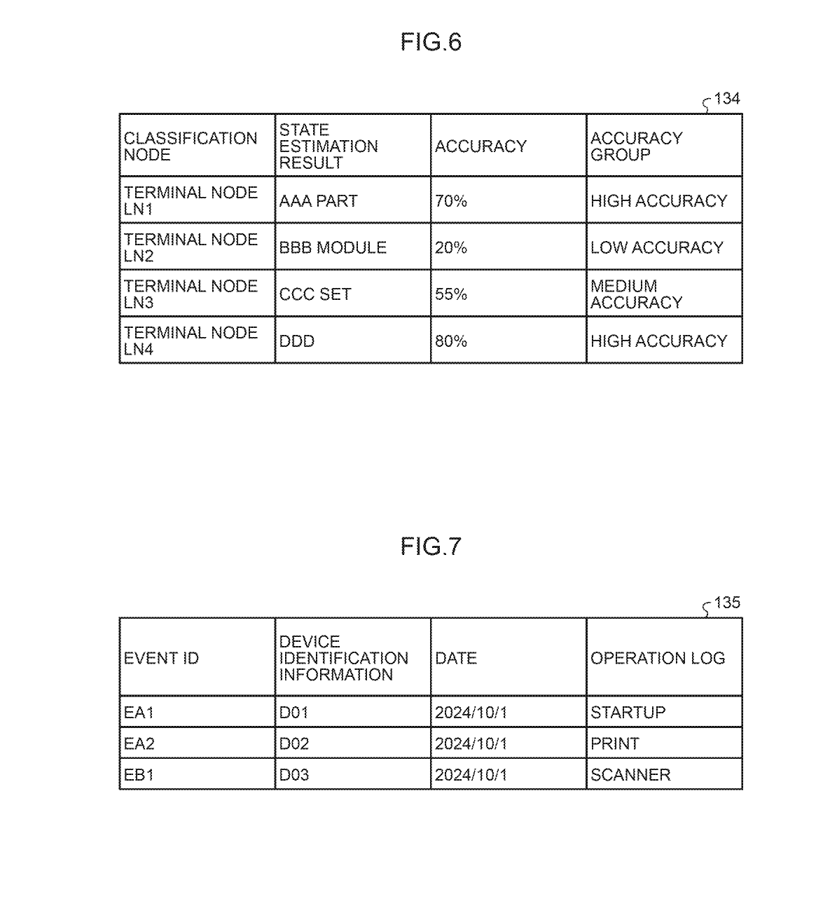

FIG. 6 is a diagram illustrating an example of a data structure of the accuracy data 134. The accuracy data 134 includes a classification node, a state estimation result, accuracy, and an accuracy group. The state estimation result represents an estimation result obtained by the model as a state corresponding to the classification node. The accuracy represents the likelihood (reliability) of the estimation of the state estimation result. The accuracy group represents a group that classifies accuracy. FIG. 6 illustrates an example in which the accuracy groups are classified into three groups of low accuracy, medium accuracy, and high accuracy. The number of groups is not limited to three. The precision group is determined, for example, according to a range of precision values.

FIG. 7 is a diagram illustrating an example of a data structure of the event data 135. The event data 135 corresponds to a plurality of pieces of event data representing a plurality of events that occurs in each of a plurality of devices including the target device. The event data 135 is acquired by the acquisition unit 101, for example, and is stored in the storage 130. The event data 135 includes an event ID, device identification information, a date, and an operation log. The operation log represents a log of an operation that takes place in association with the event identified by the event ID. The event data 135 may have a structure not including an operation log.

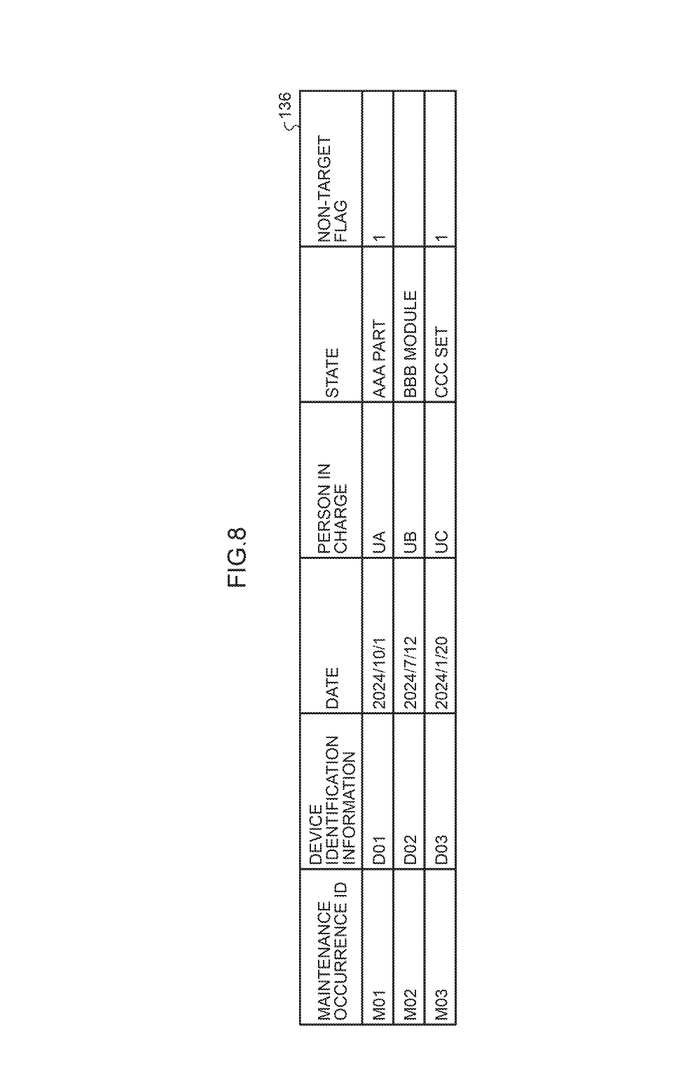

FIG. 8 is a diagram illustrating an example of a data structure of the non-target data 136. The non-target data 136 is generated by, for example, the determination unit 124 and stored in the storage 130.

The non-target data 136 includes a non-target flag in addition to each element (maintenance occurrence ID, device identification information, date, person in charge, state) of the maintenance handling data 131. The non-target flag corresponds to non-target information indicating that maintenance handling (work) of the record is data not to be estimated. For example, in a case where 1 is set, the non-target flag indicates that the record is non-target data, and in a case where other values are set, the non-target flag indicates that the record is not the non-target data.

The record of the maintenance handling data 131 to which the non-target flag is appended may be designated on the basis of the result of the maintenance handling after conducting the maintenance by, for example, the maintenance worker. In this case, for example, the acquisition unit 101 acquires a maintenance occurrence ID for identifying the designated record, and updates the non-target flag of the record identified by the acquired maintenance occurrence ID to a value (for example, 1) indicative of being the non-target (indicative of being not the target).

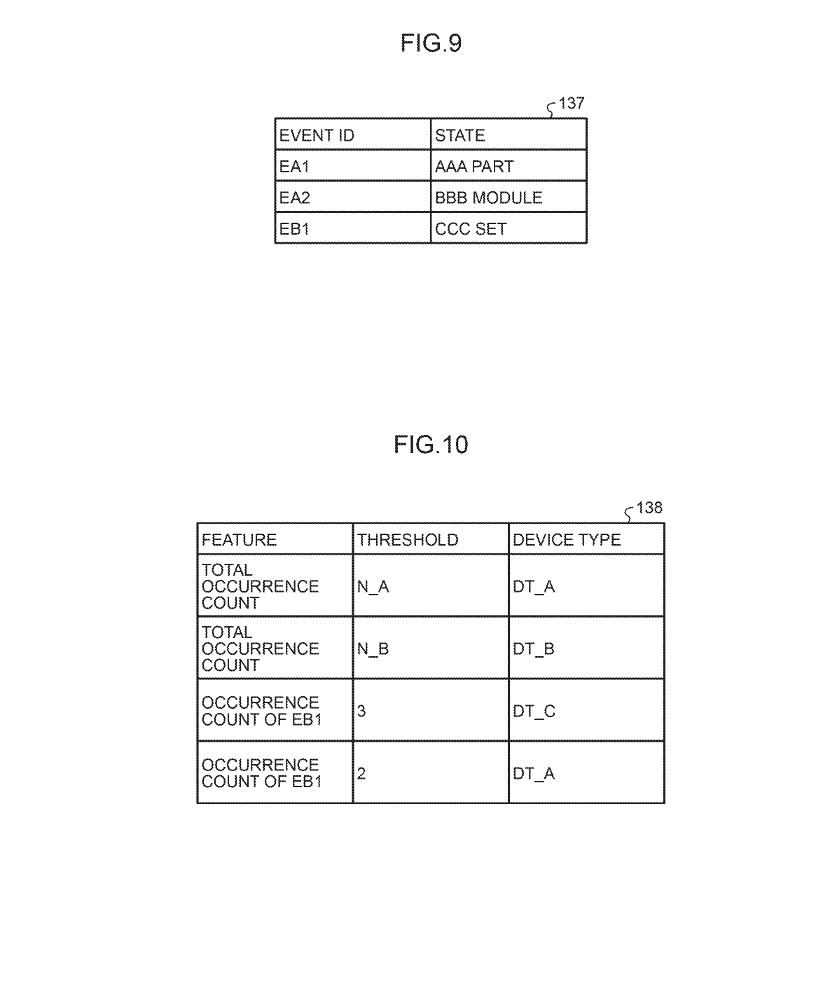

FIG. 9 is a diagram illustrating an example of a data structure of the estimation rule 137. The estimation rule 137 may be generated in advance and stored in the storage 130, or may be generated by the estimation controller 120 (the estimation rule generator 126) and stored in the storage 130.

The estimation rule 137 is a rule used in the estimation by the state estimation unit 123 as a method different from the estimation by the state estimation unit 122 using the model. The estimation rule 137 includes an event ID and a state. The state represents an estimation result of the state when the applicable event ID occurs.

FIG. 10 is a diagram illustrating an example of a data structure of the non-target determination rule 138 (determination rule). The non-target determination rule 138 may be generated in advance and stored in the storage 130, or may be generated by the determination rule learning unit 125 and stored in the storage 130.

The non-target determination rule 138 includes feature, a threshold, and a device type. The feature is data used for determination, and is, for example, the total event count of the occurred events in the extraction period (total occurrence count/total event occurrence count) and the occurrence count of the specific event. The threshold is a value used for comparison with the feature.

The non-target determination rule 138 is a rule for determining, according to the result of comparison between feature (feature vector) and a threshold, whether or not the feature vector used for estimation by the model is the non-target for estimation by the model. It can be interpreted that the determination for the non-target or target of the estimation by the model is equated to the determination as to whether or not the determination by the model is appropriate.

For example, the feature vector includes a total count (total occurrence count) of the occurred events in the extraction period and the occurrence count of the specific event. Here, the non-target determination rule

138 is a rule for determining as the non-target in a case where the total occurrence count is equal to or less than the threshold ThA (first threshold), and the occurrence count of one specific event or each of the occurrence counts of the specific events (one or more specific events) is equal to or less than one or more of threshold ThB (second threshold/second thresholds) defined for each of the one or more specific events.

In the example of FIG. 10, for a device whose device type is "DT_A", the threshold ThA is N_A, and the threshold ThB for the event (specific event) whose event ID is "EB1" is 2. In a case where a device whose device type is "DT_A" is the target device, the feature vector of the target device is determined as the non-target when the total occurrence count is equal to or less than N_A and the occurrence count of the event whose event ID is "EB1" is equal to or less than 2.

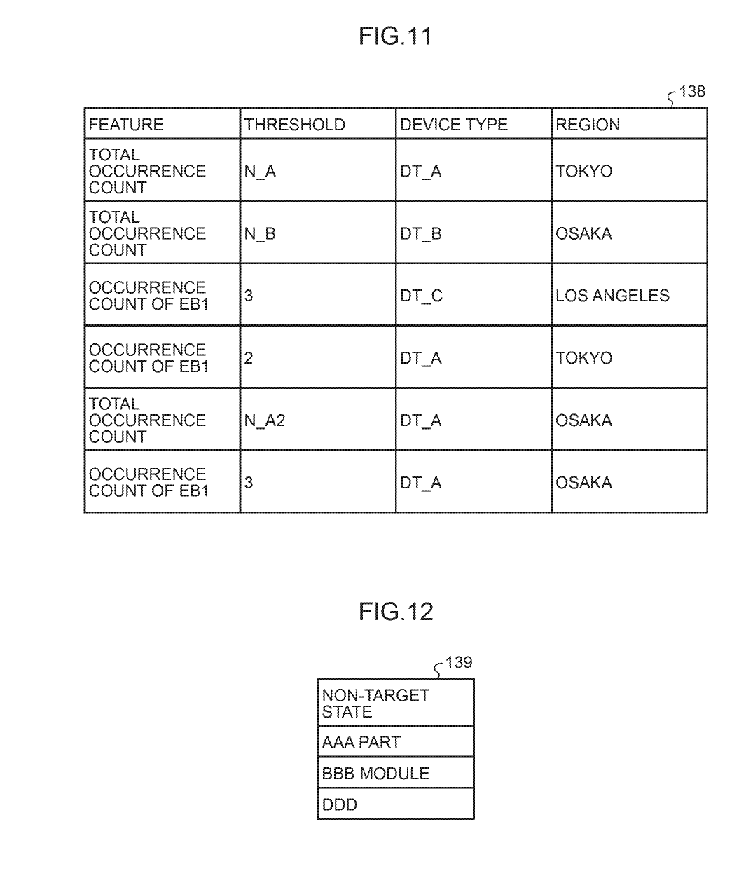

The non-target determination rule 138 may include a region in addition to the device type, and different conditions (feature and threshold) for the non-target determination may be set depending on the region. FIG. 11 is a diagram illustrating an example of a data structure of the non-target determination rule 138 including the area. As illustrated in FIG. 11, the area is, for example, a city, but is not limited thereto. For example, the area may be designated by a country.

FIG. 12 is a diagram illustrating an example of a data structure of the non-target state data 139. The non-target state data 139 is generated by, for example, the determination unit 124 and stored in the storage 130. The non-target state data 139 includes a non-target state. The non-target state represents a state determined as the non-target by the determination unit 124.

Next, details of the model learning unit 110 and the estimation controller 120 will be described. First, each unit of the model learning unit 110 will be described.

The generator 111 extracts data for learning the estimation model from the maintenance handling data 131 and the event data 135, and processes the extracted data to generate the learning data 132.

For example, the generator 111 extracts a maintenance occurrence ID, device identification information, and a date from the maintenance handling data 131. The generator 111 extracts the event ID, the device identification information, the date, and the operation log of the occurred event as necessary from the event data 135.

The generator 111 extracts one or more pieces of the event data 135 including a date in an extraction period before the reference time point and associated with device identification information matching the device identification information extracted from the maintenance handling data 131, with the date extracted from the maintenance handling data 131 as the reference time point. The generator 111 calculates the occurrence count of the event indicated by the event ID for each event ID included in the extracted event data 135. The occurrence count for each event corresponds to the feature vector described above.

The generator 111 generates the learning data 132 by adding the calculated feature vector for each maintenance occurrence ID to the maintenance handling data 131, and stores the learning data in the storage 130.

The selector 112 selects the learning data 132 to be used for model learning from the learning data 132 stored in the storage 130. For example, the selector 112 reads the non-target state data 139 from the storage 130, and selects the learning data 132 that does not include the same state as the state included in the non-target state data 139 from the learning data 132. The selector 112 also reads the non-target data 136 from the storage 130, and selects, from the learning data 132, the learning data 132 that does not include the maintenance occurrence ID that matches the maintenance occurrence ID with the value of the non-target flag of 1 in the non-target data 136.

As a result, the selector 112 can select learning data that does not include the feature vector determined as the non-target. As a result, the learning data 132 that can be noise at the time of model learning can be removed in advance, and more accurate model learning can be realized.

The learning unit 113 learns the model by using the learning data 132 selected by the selector 112. As described above, the model is learned to input the feature vector X and output the state Y corresponding to the terminal node into which the feature vector X is classified as the estimation result.

The model learning method may be any method, and for example, the following method can be used. That is, the learning unit 113 learns the model according to an algorithm that inputs a plurality of feature vectors X corresponding to a plurality of records included in the learning data 132 to the model, extracts conditions under which the state Y to be classified is classified stepwise, and divides the feature vectors X into binary tree structures according to the extracted conditions.

An example of the formal model of the learning data 132 in FIG. 3 and the decision tree in FIGS. 4 and 5 will be described. In the learning data 132 of FIG. 3, the state corresponds to the state Y that is the estimation result by the model. In addition, the occurrence count for each event such as EA1, EA2, and EB1 corresponds to the feature vector X.

A plurality of feature vectors X are input to the root of the decision tree. Two edges extending from the root correspond to a condition represented by feature and a threshold. One input feature vector is classified into one of a node N1 and a node N2 according to a condition. Similarly, a condition is associated with an edge extending from each of the node N1 and the node N2. The feature vector is classified into one of the terminal nodes LN1 to LN4 according to these conditions. Each of the terminal nodes LN1 to LN4 represents a node that does not classify the feature vector any more.

When the plurality of feature vectors X are classified, a set of feature vectors classified according to the condition of the feature is obtained for each of the terminal nodes LN1 to LN4. The ratio of the values of the state Y associated with the feature vectors included in the set is different for each of the terminal nodes LN1 to LN4. The value of the state Y associated with the feature vector can be obtained from, for example, the learning data 132.

The learning unit 113 aggregates the number of feature vectors X included in the set for each terminal node and for each value of the state Y. The learning unit 113 sets the value of the state Y having the largest number as the value of the state Y (state Y_m) representing the estimation result of the terminal node. The proportion occupied by the state Y_m in the set of terminal nodes differs for each terminal node. The higher the ratio, the higher the probability that the estimation result is correct. The ratio corresponds to the accuracy described above, which represents the certainty of the estimation result of estimating the state Y_m corresponding to the terminal node by the model.

The learning unit 113 and the evaluation unit 114 calculate such accuracy at the time of learning, generate the accuracy data 134 including the calculated accuracy, and store the accuracy data in the storage 130. For example, the learning unit 113 divides the selected learning data 132 into two at a constant ratio, and sets one as learning data 132-1 and the other as evaluation data 132-2. The evaluation data 132-2 corresponds to data for evaluating the model learned by the learning data 132-1.

The learning unit 113 learns the model according to the above procedure using the learning data 132-1. Furthermore, the learning unit 113 calculates a ratio including the state Y_m for each terminal node.

Next, the evaluation unit 114 inputs a plurality of pieces of evaluation data to the learned model and classifies the plurality of pieces of evaluation data into terminal nodes. The evaluation unit 114 calculates a ratio including the state Y_m of the classified evaluation data for each terminal node.

Next, when both the ratio calculated at the time of learning and the ratio calculated using the evaluation data are equal to or more than the threshold, the evaluation unit 114 determines that the corresponding terminal node belongs to the accuracy group indicating high accuracy. In addition, when any one of these two ratios is less than the threshold, the evaluation unit 114 determines that the corresponding terminal node belongs to the accuracy group indicating low accuracy. The evaluation unit 114 may use two or more thresholds to determine which one of three or more accuracy groups (High accuracy, medium accuracy, low accuracy, etc.) the corresponding terminal node belongs to. The evaluation unit 114 generates the accuracy data 134 including the calculated ratio as the accuracy and including the determined accuracy group, and stores the accuracy data in the storage 130.

Next, each unit of the estimation controller 120 will be described.

The extractor 121 extracts data used for estimating the state of the target device. For example, the extractor 121 extracts, from the event data 135 stored in the storage 130, one or more event data ID1 (first event data) representing one or more events that occur in the target device in an extraction period before a maintenance handling reference time point corresponding to the occurred event in the target device. For example, the extractor 121 extracts, from the event data 135, one or more event data ID1 that include device identification information matching the device identification information of the target device and have a date included in the extraction period. Furthermore, the extractor 121 aggregates the occurrence count of events included in the extracted one or more event data ID1 for each event, and generates a feature vector FV1 (first feature information) of the one or more event data ID1.

The state estimation unit 122 estimates the state of the target device using the learned model. For example, the state estimation unit 122 estimates the state of the target device by inputting the feature vector FV1 to the model. In the case of using the model represented by the decision tree as illustrated in FIG. 4, the state estimation unit 122 classifies the feature vector FV1 into any of the terminal nodes according to the condition included in the decision tree, and outputs the state Y_m associated with the classified terminal node as the estimation result. Furthermore, the state estimation unit 122 refers to, for example, the accuracy data 134 and outputs the accuracy (accuracy group) of the estimation result.

The state estimation unit 123 estimates the state of the target device using the estimation rule 137. For example, the state estimation unit 123 searches for an event ID that matches an event ID included in one or more event data ID1 among the event IDs included in the estimation rule 137, and outputs a state associated with the searched event ID as an estimation result of the state of the target device. In a case where a matching event ID is not searched, the state estimation unit 123 outputs information indicating "not applicable".

As illustrated in a flowchart to be described later, estimation by the state estimation unit 123 using the estimation rule 137 is executed before estimation by the state estimation unit 122 using the model. As a result, estimation by the simpler estimation rule 137 can be preferentially executed. That is, it is possible to more efficiently estimate the state of the device. Note that the estimation by the estimation rule 137 may not be executed. In this case, the information processing apparatus 100 may not include a configuration unit (such as the state estimation unit 123) related to estimation by the estimation rule 137.

The estimation rule 137 may further include a threshold of the occurrence count for each event ID. In this case, among the event IDs included in the estimation rule 137, the state estimation unit 123 may search for an event ID that is included in one or more event data ID1 and matches an event ID for which the occurrence count of the event is equal to or greater than a threshold, and estimate a state associated with the searched event ID as the state of the target device.

At the time of estimation by the model, there may be a situation in which there is no relevance between the tendency indicated by the feature vector used for estimation and the state of the estimation target. For example, a situation corresponds to a situation in which the occurrence count of an event (such as an error) that occurs at a low frequency is included in the feature vector even if no fault occurs. The feature vector including such an element becomes noise at the time of estimation by the model. The determination unit 124 functions as determining the possibility of estimating a state based on such an accidentally occurred event.

That is, the determination unit 124 determines whether or not the determination by the model is appropriate. For example, the determination unit 124 uses the non-target determination rule 138 to determine whether or not the feature vector FV1 of one or more pieces of event data ID1 is the non-target for estimation by the model.

For example, the determination unit 124 extracts a condition (feature and condition) associated with the device type of the target device from the non-target determination rule 138. When all the extracted conditions are satisfied, the determination unit 124 outputs a determination result indicating that the feature vector of the target device is the non-target.

The determination unit 124 may store the state corresponding to the feature vector determined as the non-target in the non-target state data 139. The state stored in the non-target state data 139 is, for example, a state output as a model estimation result.

The determination unit 124 may generate the non-target data 136 and store the non-target data in the storage 130. For example, the determination unit 124 generates the non-target data 136 in which a non-target flag, in which a value (for example, 1) indicating that the data is the non-target data is set, is appended to each element of the maintenance handling data 131 corresponding to the feature vector determined as the non-target, and stores the non-target data 136 in the storage 130. For example, when information indicative of the non-target is input by a maintenance worker, the determination unit 124 may generate the non-target data 136 in which a non-target flag is appended to each element of the applicable maintenance handling data 131 and store the non-target data in the storage 130.

The determination rule learning unit 125 learns the non-target determination rule 138 with reference to the non-target data 136 and the like. For example, the determination rule learning unit 125 reads a plurality of pieces of the non-target data 136 from the storage 130. The determination rule learning unit 125 extracts one or more event data ID1 using a reference time point (for example, a date) of the maintenance handling for each of the plurality of pieces of non-target data to which the non-target flag is appended. The determination rule learning unit 125 calculates, for each of the plurality of pieces of non-target data, one or more counts IC1 (first counts) each of which represents the occurrence count of each of one or more types of events included in one or more pieces of event data ID1, and a sum of the one or more counts IC1.

The determination rule learning unit 125 calculates statistical information of a plurality of sums calculated for a plurality of pieces of non-target data as the threshold ThA. In addition, the determination rule learning unit 125 calculates, for each of one or more types, statistical information of a plurality of counts IC1 calculated for a plurality of pieces of non-target data as the threshold ThB. The statistical information is, for example, any of a maximum value, a minimum value, a median value, an average value, and a mode value.

The estimation rule generator 126 generates the estimation rule 137. For example, although the event is related to the state of the target device, there may be a situation in which it is difficult to estimate by the model because the occurrence frequency is low. In such a situation, it may be appropriate to estimate the state by the estimation rule 137 before estimation by the model. Therefore, the estimation rule generator 126 generates the estimation rule 137 to cope with such a situation.

Hereinafter, an example will be described in which the estimation rule 137 is generated using a plurality of pieces of event data having low accuracy as a result of estimation by the model.

The estimation rule generator 126 extracts a plurality of event data ID2 (second event data) having a lower accuracy of estimation by the model than that of other event data, from among a plurality of pieces of event data used for estimation by the model. In addition, the estimation rule generator 126 acquires a state Y that is an estimation result by the model for each of the plurality of event data ID2.

The estimation rule generator 126 divides the plurality of event data ID2 into a plurality of groups for each type of the state Y. Hereinafter, the i-th (i is an integer of 1 or more and the number of groups or less; and) group is represented as Gi, and the type of state corresponding to the group Gi is represented as a state Y_i.

The estimation rule generator 126 generates, for each group Gi, the estimation rule 137 in which an event ID of an event that is included in the group Gi (first group) and is not included in a group other than the group Gi is associated with a state Y_i corresponding to the group Gi.

The estimation rule generator 126 adds the generated estimation rule 137 to the estimation rule 137 stored in the storage 130. The estimation rule generator 126 may output the generated estimation rule 137 as a recommended rule to the user through the output controller 102, for example, and may add the generated estimation rule 137 to the storage 130 when receiving an instruction to adopt the rule from the user.

The estimation controller 120 may further have a function of enabling editing at least one of the estimation rule 137 and the non-target determination rule 138. For example, the estimation controller 120 displays an editing screen for editing each rule on the display 141 via the output controller 102. The estimation controller 120 stores the rule edited on the editing screen in the storage 130.

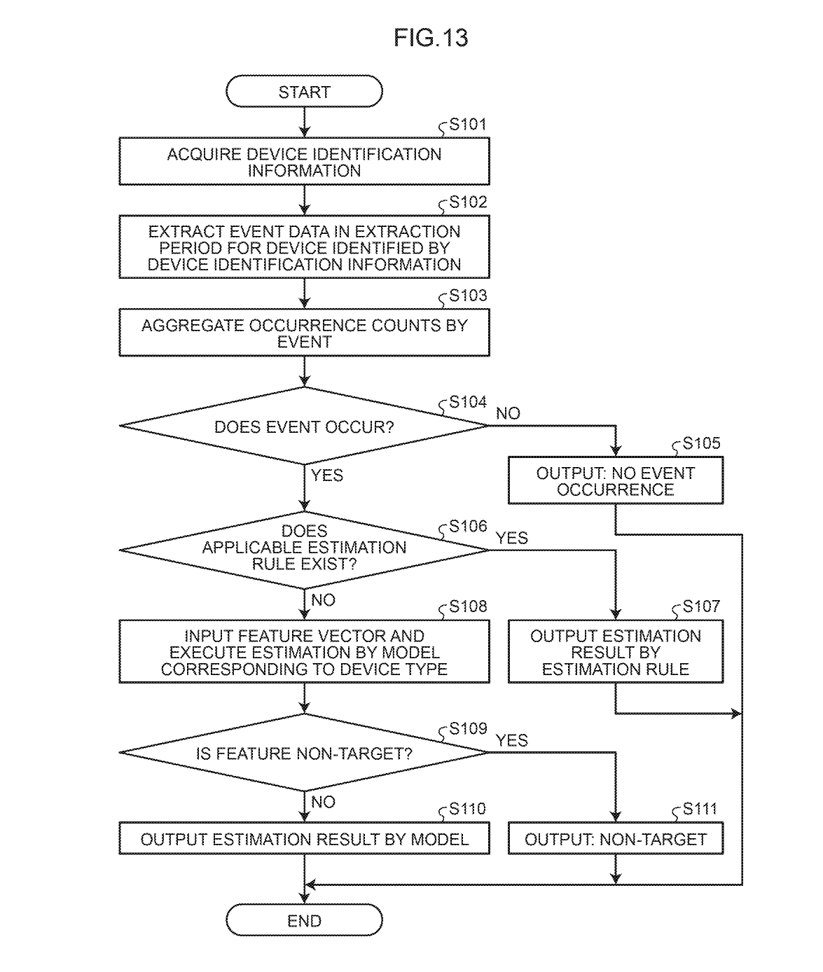

Next, estimation processing by the information processing apparatus 100 according to the embodiment will be described. The estimation process is a process for estimating the state of the target device executed by the estimation controller 120. FIG. 13 is a flowchart illustrating an example of estimation processing according to the embodiment.

The acquisition unit 101 acquires device identification information of the target device input by the user (step S101). For example, the acquisition unit 101 acquires device identification information input by the user using a display screen to be described later.

The extractor 121 extracts one or more event data ID1 in the extraction period for the target device identified by the device identification information from the event data 135 stored in the storage 130 (step S102).

The extractor 121 aggregates the occurrence counts of the event included in the extracted one or more of the event data ID1 for each event, and generates a feature vector FV1 of one or more of the event data ID1 (step S103).

The estimation controller 120 determines whether or not an event occurs (step S104). For example, the estimation controller 120 determines that no event occurs in a case where the occurrence count is 0 for all types of events, and determines that an event occurs in other cases.

When no event occurs (step S104: No), the estimation controller 120 outputs information indicative of no event occurrence (step S105), and ends the estimation processing.

When an event occurs (step S104: Yes), the state estimation unit 123 determines whether there is the estimation rule 137 corresponding to the occurred event (stored or not stored in the storage 130) (step S106).

When the estimation rule 137 corresponding to the occurred event exists (step S106: Yes), the state estimation unit 123 outputs the estimation result by the applicable estimation rule 137 (step S107), and ends the estimation processing.

When the estimation rule 137 corresponding to the occurred event does not exist (step S106: No), the state estimation unit 122 estimates the state by inputting the feature vector FV1 to the model corresponding to the device type of the target device (step S108).

The determination unit 124 uses the non-target determination rule 138 to determine whether the feature vector FV1 is the non-target for estimation by the model (step S109). In the case of not being the non-target (step S109: No), the estimation controller 120 outputs the estimation result by the model by the state estimation unit 122 (step S110), and ends the estimation processing. In the case of being the non-target (step S109: Yes), the estimation controller 120 outputs information indicative of the non-target (step S111), and ends the estimation

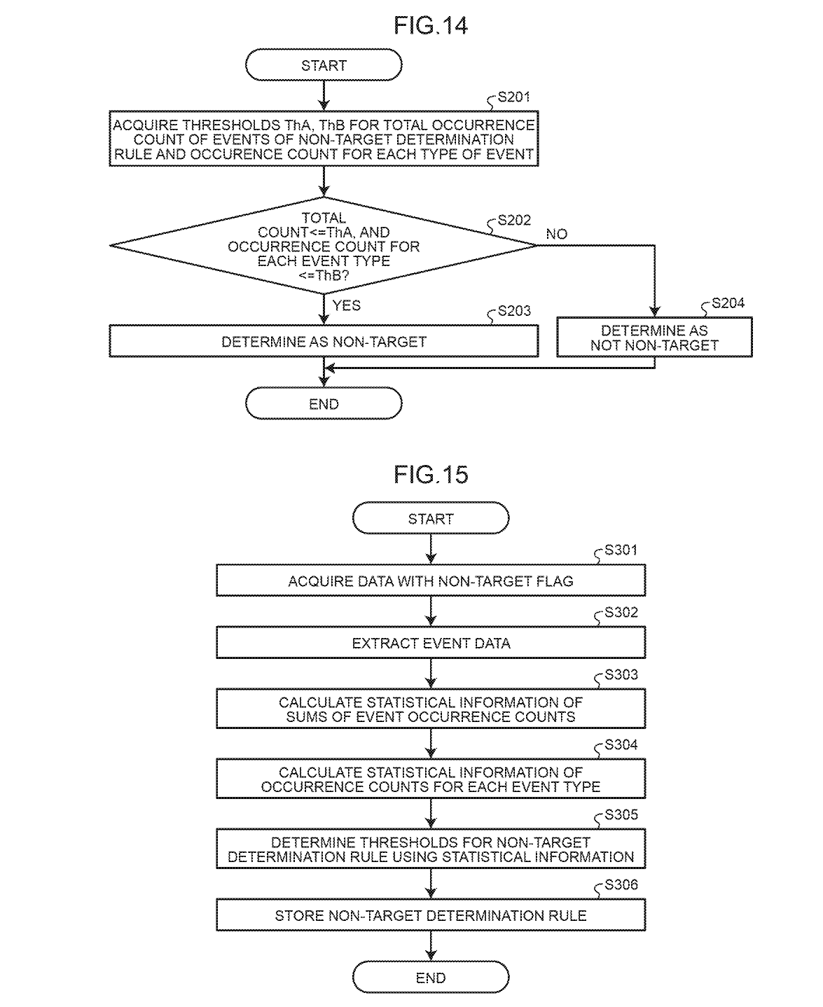

Next, details of the non-target determination processing in step S109 will be described. FIG. 14 is a flowchart illustrating an example of non-target determination processing according to the embodiment.

The determination unit 124 acquires, from the non-target determination rule 138, the threshold ThA of the total occurrence count of events (total occurrence count) corresponding to the device type of the target device and the threshold ThB of the occurrence count for each event type (step S201). The determination unit 124 determines whether the condition that the total occurrence count of events (total event occurrence count) obtained from the feature vector FV1 is equal to or less than the threshold ThA and the occurrence count for each event type is equal to or less than the threshold ThB is satisfied (step S202). When the condition is satisfied (step S202: Yes), the determination unit 124 determines the feature vector X as being the non-target, and outputs the determination result (step S203). When the condition is not satisfied (step S202: No), the determination unit 124 determines the feature vector X as not being the non-target, and outputs a determination result (step S204).

Next, determination rule learning processing by the information processing apparatus 100 according to the embodiment will be described. The determination rule learning process is a process for learning the non-target determination rule 138 executed by the determination rule learning unit 125. FIG. 15 is a flowchart illustrating an example of a determination rule learning process according to the embodiment;

The determination rule learning unit 125 acquires the plurality of pieces of non-target data 136 to which the non-target flag is appended from the storage 130 (step S301). The determination rule learning unit 125 extracts, for each of the plurality of pieces of acquired non-target data, one or more pieces of event data ID1 generated in the extraction period before the maintenance handling date (step S302).

The determination rule learning unit 125 calculates one or more counts IC1 representing the occurrence count of one or more types of events included in one or more event data ID1 and a sum of the one or more counts IC1. Then, the determination rule learning unit 125 calculates statistical information of a plurality of sums calculated for a plurality of pieces of non-target data (step S303). In addition, the determination rule learning unit 125 calculates statistical information of a plurality of counts IC1 calculated for a plurality of pieces of non-target data for each of one or more event types (step S304).

The determination rule learning unit 125 determines a threshold used in the non-target determination rule 138 by using the calculated statistical information (step S305). For example, the determination rule learning unit 125 determines the statistical information of the plurality of sums calculated in step S303 as the threshold ThA. In addition, the determination rule learning unit 125 determines the statistical information of the plurality of counts IC1 calculated in step S304 as the threshold ThB.

The determination rule learning unit 125 generates a non-target determination rule in which the determined threshold is set, and stores the non-target determination rule 138 in the storage 130 (step S306). In addition, in the present embodiment, the thresholds and determination rules are not statically defined but are automatically optimized through ongoing statistical analysis of maintenance history and event data. By continuously collecting and analyzing actual maintenance records and event occurrences, the information processing apparatus 100 dynamically updates the non-target determination rules and associated thresholds. This approach enables the estimation processing to flexibly adapt to changes in device usage patterns and environmental conditions, thereby enhancing the accuracy and reliability of state estimation compared to conventional methods that rely on fixed or manually set thresholds.

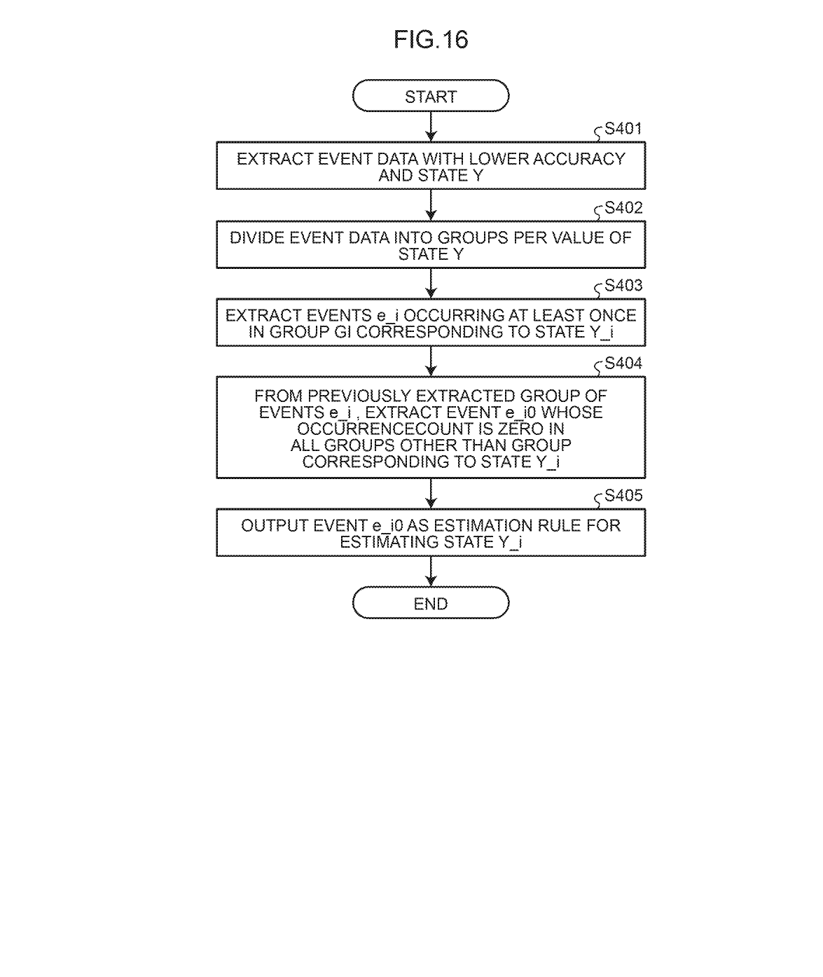

Next, estimation rule generation processing by the information processing apparatus 100 according to the embodiment will be described. The estimation rule generation process is a process for generating the estimation rule 137 executed by the estimation rule generator 126. FIG. 16 is a flowchart illustrating an example of estimation rule generation processing according to the embodiment.

The estimation rule generator 126 extracts a plurality of event data ID2 of which estimation accuracy by the model is lower than that of other event data and a state Y that is an estimation result by the model for each of the plurality of event data ID2 from among the plurality of event data (step S401).

The estimation rule generator 126 divides the plurality of event data ID2 into a plurality of groups per value (type) of the state Y (step S402).

The estimation rule generator 126 extracts one or more events e_i that occur at least once in the group Gi corresponding to the state Y_i (step S403). From the previously extracted group of the events e_i, the estimation rule generator 126 extracts an event e_i0 whose occurrence count is zero (0) in all groups of the states other than the group Gi corresponding to (in) the state Y_i (step S404).

The estimation rule generator 126 generates and outputs the estimation rule 137 that outputs the state Y_i as the estimation result when the event e_i0 occurs, that is, the estimation rule 137 in which the event ID of the event e_i0 and the state Y_i are associated with each other (step S405). In other words, in Step S405, the estimation rule generator 126 outputs the event e_i0 as the estimation rule 137 for estimating the state Y_i.

Next, an output example by the output controller 102 will be described. The estimation result by the estimation processing is output (displayed) on a display screen or the like by the output controller 102, for example. For example, the output controller 102 may display a display screen including the estimation result of the state by the model and the determination result by the non-target determination rule 138 on the display 141.

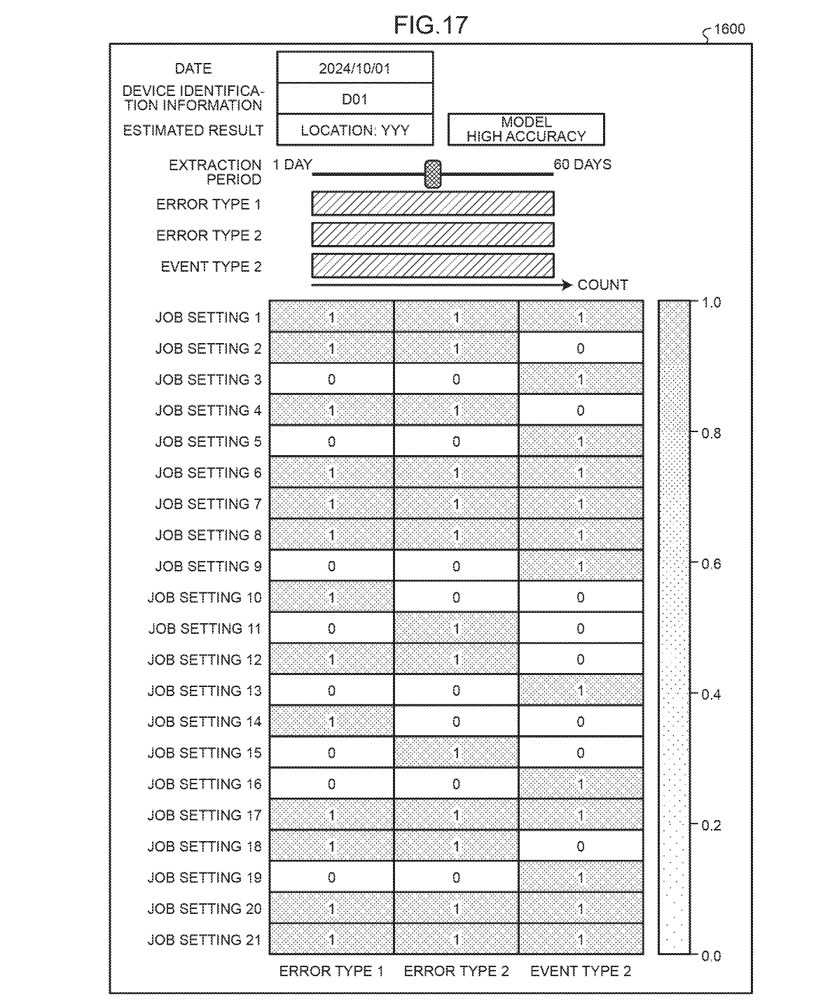

FIG. 17 is a diagram illustrating an example of a display screen 1600 displayed on the display 141 by the output controller 102.

The date, the device identification information, and the extraction period are input or designated by the user, for example. A result estimated according to the input information is displayed as an estimation result.

Error type 1, error type 2, and event type 2 are examples of event types. The count represents the occurrence count of events in the extraction period for each type of event. In this manner, on the display screen 1600, information corresponding to a tabulation of the occurrence count for each event is displayed.

In the lower part of the display screen 1600, information corresponding to a cross tabulation table between job settings and events is displayed. The job setting represents a setting of a job executed by the target device.

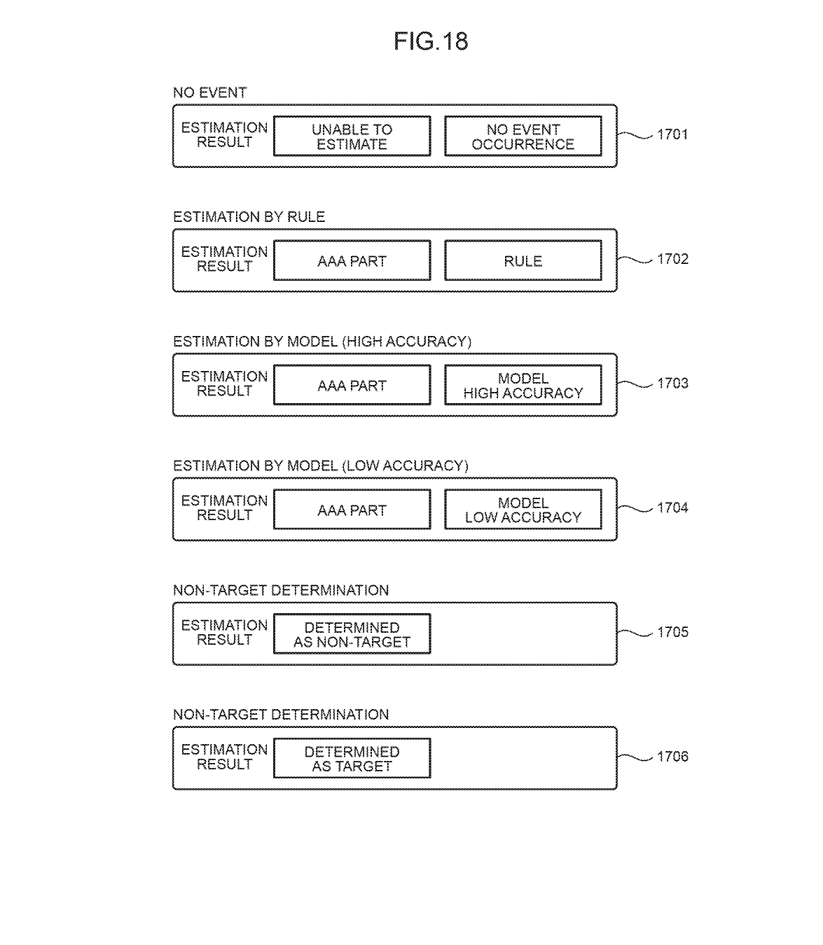

In the column of the estimation result, different information is displayed according to a model, an estimation rule, or the like used for estimation. FIG. 18 is a diagram illustrating an example of display information 1701 to 1706 displayed in the column of the estimation result.

The display information 1701 to 1706 corresponds to information displayed in the following cases.

Display information 1701: in the case of no event occurrence (corresponding to step S105)

Display information 1702: in the case of being estimated by estimation rule (corresponding to step S107)

Display information 1703: in the case of a highly accurate estimation result being estimated by the model (corresponding to step S110)

Display information 1704: in the case of a low-accuracy estimation result being estimated by the model (corresponding to step S110)

Display information 1705: in the case of being determined as non-target (corresponding to step S111)

Display information 1706: in the case of being not determined as non-target (determined as the target)

Note that the display information 1706 indicative of being not determined as the non-target may be displayed together with the display information 1703 or the display information 1704.

Hereinafter, a usage example of the present embodiment will be described.

When some sort of problem occurs in the target device, an inquiry from the user occurs. When an inquiry occurs, for example, a management device that manages the inquiry issues a maintenance occurrence ID which is identification information for identifying occurrence of the inquiry (occurrence of maintenance handling). In addition, the management device generates the maintenance handling data 131 including the maintenance occurrence ID. The acquisition unit 101 acquires the generated maintenance handling data 131 from the management device.

The maintenance worker visits the user to conduct maintenance on the target device. At the time of work to identify the cause of the problem for the target device, the maintenance worker inputs the device identification information, the date, and the maintenance occurrence ID of the target device to the information processing apparatus 100 using, for example, the display screen 1600 or the like. A method of inputting information may be any method, and for example, a method of inputting information using a terminal device (a mobile terminal or the like) connected to the information processing apparatus 100 via a network (the Internet or the like) can be applied.

The maintenance worker instructs execution of estimation using, for example, the display screen 1600. In response to the instruction, the information processing apparatus 100 estimates the state of the target device by the method of the above embodiment, and displays the estimation result on the display screen 1600.

The maintenance worker identifies a cause of the problem for the target device, that is, a state such as a failure location of the target device while referring to the estimation result. The maintenance worker may specify the same state as the estimation result, or may specify a state different from the estimation result. For example, in the case of a defect only in the appearance of the target device or in the case where the defect is caused by the environment of the user, a state different from the estimation result can be specified.

When a state different from the estimation result is specified, the maintenance worker inputs information indicating that the maintenance handling data 131 corresponding to the maintenance occurrence ID, for which the maintenance work is conducted, is irrelevant to (is the non-target for) the estimation by the rule or the model. For example, the maintenance worker inputs the information to the information processing apparatus 100 via an input screen different from the display screen 1600.

When the information indicative of the non-target is input, the determination unit 124 generates the non-target data 136 in which the non-target flag is appended to each element of the applicable maintenance handling data 131, and stores the non-target data in the storage 130.

The non-target data 136 is used in learning of the non-target determination rule 138 by the determination rule learning unit 125. By performing learning, the accuracy of determination by the non-target determination rule 138 can be improved. That is, it is possible to determine with higher accuracy whether or not the event data (feature vector) used at the time of maintenance handling is the non-target for estimation by the model. As a result, it is possible to more efficiently estimate the state of the device.

In the present embodiment, an estimation result indicative of the non-target can be output (for example, the display information 1705 in FIG. 18). In such a case, the maintenance worker can execute the work of estimating the state of the target device without referring to the estimation result of the model. That is, the maintenance worker can reduce the load of the work of specifying the state by referring to the estimation result of the non-target.

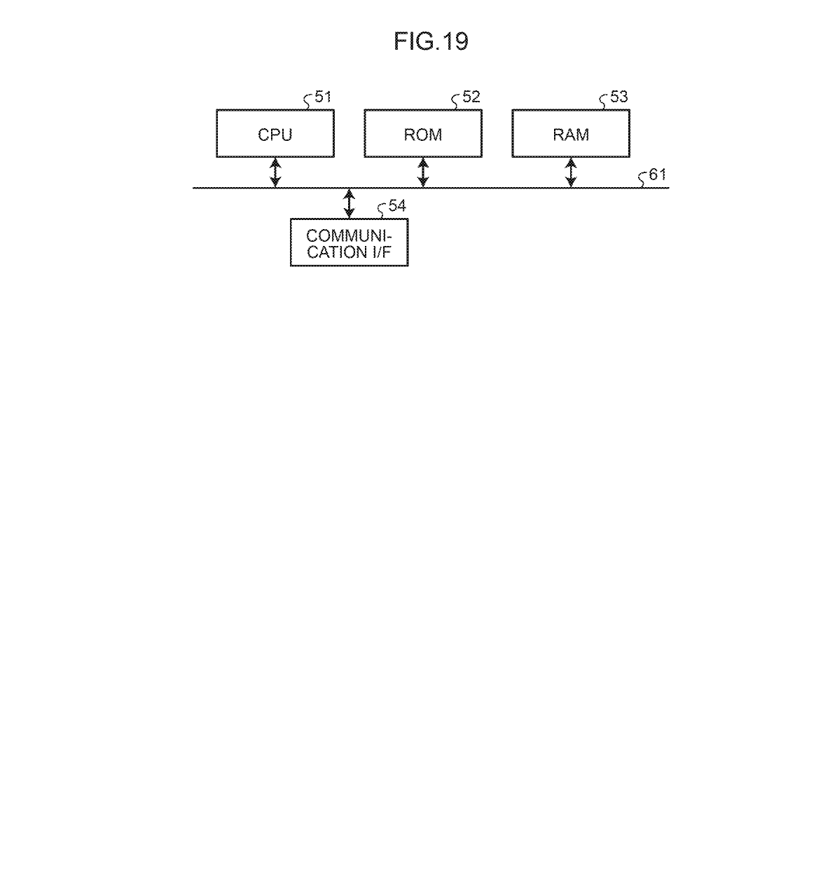

Next, a hardware configuration of the information processing apparatus according to the embodiment will be described with reference to FIG. 19. FIG. 19 is an explanatory diagram illustrating a hardware configuration example of the information processing apparatus according to the embodiment.

The information processing apparatus according to the embodiment includes a control device such as a Central Processing Unit (CPU) 51, a storage device such as a Read Only Memory (ROM) 52 and a Random Access Memory (RAM) 53, a communication I/F 54 that is connected to a network and performs communication, and a bus 61 that connects the respective units.

The program executed by the information processing apparatus according to the embodiment is provided by being incorporated in the ROM 52 or the like in advance.

The program executed by the information processing apparatus according to the embodiment may be provided as a computer program product by being recorded as a file in an installable format or an executable format in a computer-readable recording medium such as a Compact Disk Read Only Memory (CD-ROM), a flexible disk (FD), a Compact Disk Recordable (CD-R), or a Digital Versatile Disk (DVD).

Furthermore, the program executed by the information processing apparatus according to the embodiment may be stored on a computer connected to a network such as the Internet and provided by being downloaded via the network. Furthermore, the program executed by the information processing apparatus according to the embodiment may be provided or distributed via a network such as the Internet.

The program executed by the information processing apparatus according to the embodiment can cause a computer to function as each unit of the information processing apparatus described above. In this computer, the CPU 51 can read a program from a computer-readable storage medium onto a main storage device and execute the program.

Configuration examples of the embodiments will be described below.

Configuration Example 1. An information processing apparatus according to an embodiment includes a processing unit including one or more hardware processors. The processing unit executes extracting, from a plurality of pieces of event data representing a plurality of events that occurs in each of a plurality of devices, one or more pieces of first event data representing one or more events that occur in a first device among the plurality of devices in an extraction period of a certain length before a reference time point based on a work in accordance with each of the one or more events that occur in the first device as a state estimation target. The processing unit executes estimating a state of the first device by inputting first feature information of the one or more pieces of first event data to a model that inputs feature information of one or more pieces of event data and outputs a state estimation result of a device. The processing unit executes determining, by using a determination rule for determining whether or not feature information of the one or more pieces of event data on the one or more events that occur in the extraction period is a non-target for estimation by the model, whether or not the first feature information of the one or more pieces of first event data is the non-target for estimation by the model. The processing unit executes outputting the state estimation result by the model and a determination result by the determination rule.

Configuration Example 2. In the information processing apparatus according to configuration example 1, the determination rule is a rule used for determining for being the non-target or being not the non-target according to a result of comparison between feature information of the one or more pieces of event data on the one or more events that occur in the extraction period and a threshold.

Configuration Example 3. In the information processing apparatus according to configuration example 1, the feature information of the one or more pieces of event data on the one or more events that occur in the extraction period includes a total event occurrence count in the extraction period and an occurrence count of one or more specific events that occur in the extraction period, and the determination rule is a rule for determining as the non-target in a case where the total event occurrence count is equal to or less than a first threshold and each of occurrence counts of the one or more specific events is equal to or less than one or more second thresholds defined for each of the one or more specific events.

Configuration Example 4. In the information processing apparatus according to configuration example 3, the processing unit executes storing, in storage, a plurality of pieces of non-target data obtained by appending non-target information indicative of being the non-target for estimation by the model to a history of a plurality of works in accordance with respective events that occur in the plurality of devices. The processing unit executes storing, in storage, a plurality of pieces of non-target data obtained by appending non-target information indicative of being the non-target for estimation by the model to a history of a plurality of works in accordance with respective events that occur in the plurality of devices. The processing unit executes calculating, for each of the plurality of pieces of non-target data to which the non-target information is appended, one or more first counts each representing an event occurrence count for each of one or more types of events included in one or more pieces of the first event data extracted by using the reference time point based on the work, and a sum of the one or more first counts. The processing unit executes calculating statistical information of a plurality of sums calculated for the plurality of pieces of non-target data as the first threshold. The processing unit executes calculating, for each of the one or more types, a plurality of pieces of statistical information of the first counts calculated for the plurality of pieces of non-target data as the second thresholds.

Configuration Example 5. In the information processing apparatus according to any one of configuration examples 1 to 4, the processing unit executes learning the model by using learning data that does not include the first feature information determined as the non-target.

Configuration Example 6. In the information processing apparatus according to any one of configuration examples 1 to 5, the processing unit executes estimating the state associated with the identification information of the event included in the one or more pieces of first event data as the state of the first device by using an estimation rule in which the identification information of the event and the state are associated with each other.

Configuration Example 7. In the information processing apparatus according to configuration example 6, the processing unit executes extracting second event data that is a plurality of pieces of event data having a lower accuracy of estimation by the model than that of other pieces of event data, from among the plurality of pieces of event data used for estimation by the model. The processing unit executes dividing the plurality of pieces of extracted second event data into a plurality of groups for each type of a state estimated by the model. The processing unit executes generating the estimation rule in which identification information of an event included in a first group among the plurality of groups and not included in a group other than the first group among the plurality of groups is associated with a state corresponding to the first group.

Configuration Example 8. According to an embodiment, an information processing method is executed by an information processing apparatus. The method includes (i) extracting, from a plurality of pieces of event data representing a plurality of events that occurs in each of a plurality of devices, one or more pieces of first event data representing one or more events that occur in a first device among the plurality of devices in an extraction period of a certain length before a reference time point based on a work in accordance with each of the one or more events that occur in the first device as a state estimation target; (ii) estimating a state of the first device by inputting first feature information of the one or more pieces of first event data to a model that inputs feature information of one or more pieces of event data and outputs a state estimation result of a device; (iii) determining, by using a determination rule for determining whether or not feature information of the one or more pieces of event data on the one or more events that occur in the extraction period is a non-target for estimation by the model, whether or not the first feature information of the one or more pieces of first event data is the non-target for estimation by the model; and (iv) outputting the state estimation result by the model and a determination result by the determination rule.

Configuration Example 9. According to an embodiment, a computer program product has a non-transitory computer readable medium including instructions stored thereon. When executed by a computer, the instructions cause the computer to execute (i) extracting, from a plurality of pieces of event data representing a plurality of events that occurs in each of a plurality of devices, one or more pieces of first event data representing one or more events that occur in a first device among the plurality of devices in an extraction period of a certain length before a reference time point based on a work in accordance with each of the one or more events that occur in the first device as a state estimation target; (ii) estimating a state of the first device by inputting first feature information of the one or more pieces of first event data to a model that inputs feature information of one or more pieces of event data and outputs a state estimation result of a device; (iii) determining, by using a determination rule for determining whether or not feature information of the one or more pieces of event data on the one or more events that occur in the extraction period is a non-target for estimation by the model, whether or not the first feature information of the one or more pieces of first event data is the non-target for estimation by the model; and (iv) outputting the state estimation result by the model and a determination result by the determination rule.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
one or more hardware processors configured to:
extract, from a plurality of pieces of event data representing a plurality of events that occurs in each of a plurality of devices, one or more pieces of first event data representing one or more events that occur in a first device among the plurality of devices in an extraction period of a certain length before a reference time point based on a work in accordance with each of the one or more events that occur in the first device as a state estimation target;
estimate a state of the first device by inputting first feature information of the one or more pieces of first event data to a model that inputs feature information of one or more pieces of event data and outputs a state estimation result of a device;
determine, by using a determination rule for determining whether or not feature information of the one or more pieces of event data on the one or more events that occur in the extraction period is a non-target for estimation by the model, whether or not the first feature information is the non-target for estimation by the model; and
output the state estimation result by the model and a determination result by the determination rule.

2. The information processing apparatus according to claim 1, wherein
the determination rule is a rule used for determining for being the non-target or being not the non-target according to a result of comparison between feature information of the one or more pieces of event data on the one or more events that occur in the extraction period and a threshold.

3. The information processing apparatus according to claim 1, wherein
the feature information of the one or more pieces of event data on the one or more events that occur in the extraction period includes a total event occurrence count in the extraction period and an occurrence count of one or more specific events that occur in the extraction period, and
the determination rule is a rule for determining as the non-target in a case where the total event occurrence count is equal to or less than a first threshold and each of occurrence counts of the one or more specific events is equal to or less than one or more second thresholds defined for each of the one or more specific events.

4. The information processing apparatus according to claim 3, wherein
the one or more hardware processors are further configured to:
store, in storage, a plurality of pieces of non-target data obtained by appending non-target information indicative of being the non-target for estimation by the model to a history of a plurality of works in accordance with respective events that occur in the plurality of devices;
calculate, for each of the plurality of pieces of non-target data to which the non-target information is appended, one or more first counts each representing an event occurrence count for each of one or more types of events included in one or more pieces of the first event data extracted by using the reference time point based on the work, and a sum of the one or more first counts;
calculate statistical information of a plurality of sums calculated for the plurality of pieces of non-target data as the first threshold; and
calculate, for each of the one or more types, a plurality of pieces of statistical information of the first counts calculated for the plurality of pieces of non-target data as the second thresholds.

5. The information processing apparatus according to claim 1, wherein
the one or more hardware processors are further configured to:
learn the model by using learning data that does not include the first feature information determined as the non-target.

6. The information processing apparatus according to claim 1, wherein
the one or more hardware processors are further configured to:
estimate the state associated with the identification information of the event included in the one or more pieces of first event data as the state of the first device by using an estimation rule in which the identification information of the event and the state are associated with each other.

7. The information processing apparatus according to claim 6, wherein
the one or more hardware processors are further configured to:
extract second event data that is a plurality of pieces of event data having a lower accuracy of estimation by the model than that of other pieces of event data, from among the plurality of pieces of event data used for estimation by the model;
divide the plurality of pieces of extracted second event data into a plurality of groups for each type of a state estimated by the model; and
generate the estimation rule in which identification information of an event included in a first group among the plurality of groups and not included in a group other than the first group among the plurality of groups is associated with a state corresponding to the first group.

8. An information processing method executed by an information processing apparatus, the method comprising:
extracting, from a plurality of pieces of event data representing a plurality of events that occurs in each of a plurality of devices, one or more pieces of first event data representing one or more events that occur in a first device among the plurality of devices in an extraction period of a certain length before a reference time point based on a work in accordance with each of the one or more events that occur in the first device as a state estimation target;
estimating a state of the first device by inputting first feature information of the one or more pieces of first event data to a model that inputs feature information of one or more pieces of event data and outputs a state estimation result of a device;
determining, by using a determination rule for determining whether or not feature information of the one or more pieces of event data on the one or more events that occur in the extraction period is a non-target for estimation by the model, whether or not the first feature information is the non-target for estimation by the model; and
outputting the state estimation result by the model and a determination result by the determination rule.

9. A computer program product having a non-transitory computer readable medium including instructions stored thereon, wherein the instructions, when executed by a computer, cause the computer to execute:
extracting, from a plurality of pieces of event data representing a plurality of events that occurs in each of a plurality of devices, one or more pieces of first event data representing one or more events that occur in a first device among the plurality of devices in an extraction period of a certain length before a reference time point based on a work in accordance with each of the one or more events that occur in the first device as a state estimation target;
estimating a state of the first device by inputting first feature information of the one or more pieces of first event data to a model that inputs feature information of one or more pieces of event data and outputs a state estimation result of a device;
determining, by using a determination rule for determining whether or not feature information of the one or more pieces of event data on the one or more events that occur in the extraction period is a non-target for estimation by the model, whether or not the first feature information is the non-target for estimation by the model; and
outputting the state estimation result by the model and a determination result by the determination rule.
